(19) United States
(12) Patent Application Publication
(10) Pub. No.: US 2025/0023370 A1
(43) Pub. Date: Jan. 16, 2025

(54) POWER BANKS FOR CHARGING MOBILE DEVICES

(71) Applicant: RFA Brands, LLC DBA My Charge LIMITED LIABILITY COMPANY, Birmingham, MI (US)

(72) Inventors: Roman Ferber, Birmingham, MI (US); Nicholas Wayne HOWELL, Northville, MI (US)

(21) Appl. No.: 18/350,159

(22) Filed: Jul. 11, 2023

(51) Int. Cl. H02J 7/00; H01R 13/502; H01R 13/72; H01R 31/06

(52) U.S. Cl. CPC H02J 7/0042; H01R 13/502; H01R 13/72; H01R 31/065

(57) ABSTRACT

An adapter plug for a power bank includes a housing, electrical connectors, prongs, and an electrical circuit. The electrical connector associated with the housing and are configured to contact an electrical connector of a power bank. The prongs are configured to engage an electrical wall outlet. The electrical circuit is disposed within the housing and electrically connects the prongs to the electrical connectors. The prongs, electrical circuit, and the electrical connector of the housing is configured to deliver electrical power from the electrical wall outlet to the power bank to recharge a battery of the power bank when the electrical connector of the housing contacts the electrical connector of the power bank and when the prongs engage the electrical wall outlet.

### TECHNICAL FIELD

The present disclosure relates to power banks configured to charge mobile devices. In some respects, the present disclosure includes adapter plugs configured to charge power banks.

### BACKGROUND

Power banks may be utilized to charge the batteries of mobile devices such as mobile phones.

### SUMMARY

In one embodiment, an adapter plug for a power bank includes a housing, electrical connectors, prongs, and an electrical circuit. The electrical connector associated with the housing and are configured to contact an electrical connector of a power bank. The prongs are configured to engage an electrical wall outlet. The electrical circuit is disposed within the housing and electrically connects the prongs to the electrical connectors. The prongs, electrical circuit, and the electrical connector of the housing is configured to deliver electrical power from the electrical wall outlet to the power bank to recharge a battery of the power bank when the electrical connector of the housing contacts the electrical connector of the power bank and when the prongs engage the electrical wall outlet.

In another embodiment, a power bank configured to charge portable devices includes a housing, a first battery, a primary coil, and a cable. The first battery is disposed within the housing. The primary coil is electrically connected to the first battery and is disposed within the housing below the external panel. The primary coil is configured to interact with a secondary coil of a portable device to deliver electrical power from the first battery to a second battery that is secured to the portable device to charge the second battery in response to the portable device being disposed on or proximate to the external panel. The cable is secured to the housing and has a connector. The connector is configured to engage an electrical port such that electrical power is delivered from the electrical port to the first battery to charge the first battery or such that electrical power is delivered from the first battery to the second battery.

In yet another embodiment, a power bank configured to charge portable devices includes a housing, a first battery, a primary coil, and a port. The first battery is disposed within the housing. The primary coil is electrically connected to the first battery and is disposed within the housing below the external panel. The primary coil is configured to interact with a secondary coil of a portable device to deliver electrical power from the first battery to a second battery secured to the portable device to charge the second battery in response to the portable device being disposed on or proximate to the external panel. The port is secured to the housing and configured to receive a cable configured to deliver electrical power from an electrical wall outlet to the first battery to charge the first battery.

### BRIEF DESCRIPTION OF THE DRAWINGS

FIG. 1 is a perspective view of an adapter plug configured to attach to the power bank to charge (e.g., recharge) a battery of the power bank;

FIG. 2 is a partial exploded view of the adapter plug;

FIG. 3 is a diagram illustrating electrical components of the adapter plug, the power bank, and a power grid;

FIG. 4 is a front view of the power bank with the adapter plug attached to the power bank;

FIG. 5 is a rear view of the power bank with the adapter plug attached to the power bank;

FIG. 6 is a side view of the power bank illustrating a kickstand in an advanced position;

FIG. 7 is a bottom view of the power bank illustrating the kickstand in the advanced position;

FIG. 8 is a perspective view of an adapter plug configured to attach to a power bank in an alternative configuration to charge (e.g., recharge) a battery of the power bank;

FIG. 9 is a side view of the adapter plug configuration shown in FIG. 8;

FIG. 10 is a right-side perspective view of an alternative configuration of the adapter plug and the power bank;

FIG. 11 is a left-side perspective view of the adapter plug and the power bank shown in FIG. 10;

FIG. 12 is a front perspective view of an embodiment of the power bank;

FIG. 13 is a rear perspective view of the embodiment of the power bank shown in FIG. 12;

FIG. 14 is a front perspective view of an embodiment of a power bank;

FIG. 15 is a rear perspective view of the embodiment of the power bank shown in FIG. 14;

FIG. 16 is a control diagram for various subcomponents of the power bank shown in FIGS. 12 to 15;

FIG. 17 is a diagram illustrating electrical components of the power bank and a portable device chargeable by the power bank;

FIG. 18 is a diagram illustrating a sensor that is a subcomponent of the power bank and a power source for the sensor;

FIG. 19 is a front perspective view of an embodiment of the power bank with an electrical cable illustrated in a stowed position;

FIG. 20 is a front perspective view of the embodiment of the power bank of FIG. 19 with the electrical cable illustrated in an operational position;

FIG. 21 is a bottom perspective view of the embodiment of the power bank of FIG. 19 with the electrical cable illustrated in the stowed position; and

FIG. 22 is a front view of the embodiment the power bank of FIG. 19.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

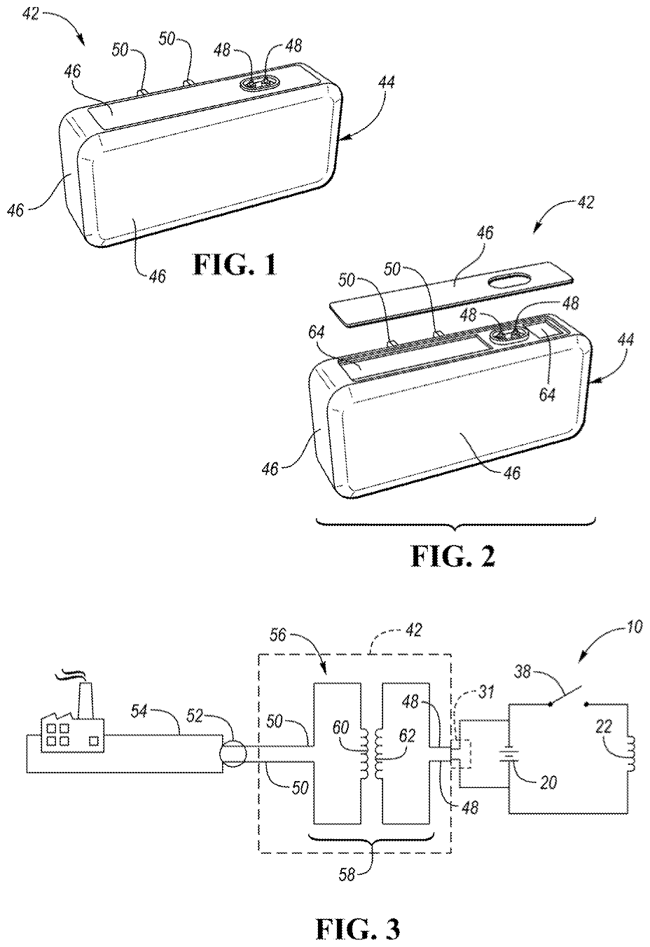

Referring to FIGS. 1 to 3, an adapter plug 42 configured to engage a power bank to recharge a battery of the power bank is illustrated. The adapter plug 42 is separate from or external to the power bank. The adapter plug 42 is attachable to and detachable from the power bank. The adapter plug 42 is attachable to and detachable from a housing of the power bank. The adapter plug 42 includes a housing 44 having external panels 46.

The adapter plug 42 includes pins 48 that protrude from the housing 44 (or other electrical connectors (e.g., inductive connector) associated with housing 44). The pins 48 are configured to engage an electrical outlet (e.g., a port) defined by the power bank. The pins 48 may also be disengaged from the electrical outlet. The pins 48 may be pogo or spring-loaded pins. The adapter plug 42 also includes prongs 50 that protrude from the housing 44. The prongs 50 are configured to engage an electrical wall outlet 52. The electrical wall outlet 52 is connected to and configured to receive power from a power source, such as a power grid 54. The prongs 50 may also be disengaged from the electrical wall outlet 52. The pins 48 and the prongs 50 may protrude from different external panels 46 of the housing 44. The external panel 46 that the pins 48 protrude from may be substantially perpendicular to the external panel 46 that the prongs 50 protrude from. Substantially perpendicular (e.g., incremental integers) may refer to any incremental angle that ranges between exactly perpendicular and 15° from exactly perpendicular.

The adapter plug 42 also includes an electrical circuit 56 disposed within the housing 44. The electrical circuit 56 electrically connects the prongs 50 to the pins 48. As shown in FIG. 3, the power bank 10 includes an electrical circuit including primary coil 22, switch 38, port 31, and battery 20. The (i) prongs 50, (ii) the electrical circuit 56 of the adapter plug 42, (iii) the pins 48, and (iv) the electrical circuit of the power bank 10 connecting the electrical outlet (e.g., port 31) to the battery 20 of the power bank 10 are configured to deliver electrical power from the electrical wall outlet 52 to the battery 20 of the power bank 10 to recharge the battery 20 when the pins 48 are engaging the electrical outlet (e.g., port 31) defined by the power bank 10 and when the prongs 50 are engaging the electrical wall outlet 52. The electrical circuit 56 may include a step-down converter 58 that is configured to decrease a voltage from the electrical wall outlet 52 being delivered to the pins 48 and ultimately to the battery 20 of the power bank 10. The step-down converter 58 may be a transformer that includes a primary coil 60 and a secondary coil 62.

The adapter plug 42 may include magnets 64 disposed proximate to an external surface or proximate to one of the external panels 46 of the housing 44 of the adapter plug 42. The magnets 64 may be disposed below one of the external panels 46 that acts as a cover for the magnets 64. The external panel 46 covering the magnets 64 may be sufficiently thin so that the strength of the magnetic attraction through the external panel 46 covering the magnets 64 is not reduced or is only reduced a negligible amount. The magnets 64 may be disposed on first and second opposing sides of the pins 48. The magnets 64 and pins 48 may be disposed on an edge (e.g., a relatively narrow side) of the adapter plug 42, or on an edge of the housing 44 of the adapter plug. The magnets 64 are configured to engage the power bank 10, or more superficially the housing 12 of the power bank 10, to secure the adapter plug 64 to the housing 12 of the power bank 10 and to facilitate engagement and alignment between the pins 48 and the electrical outlet (e.g., port 31) defined by the power bank 10.

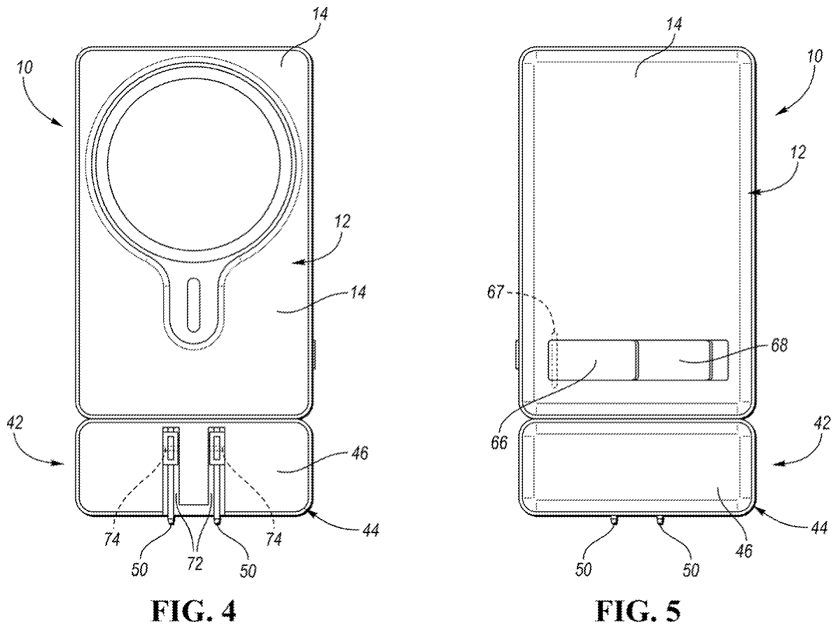

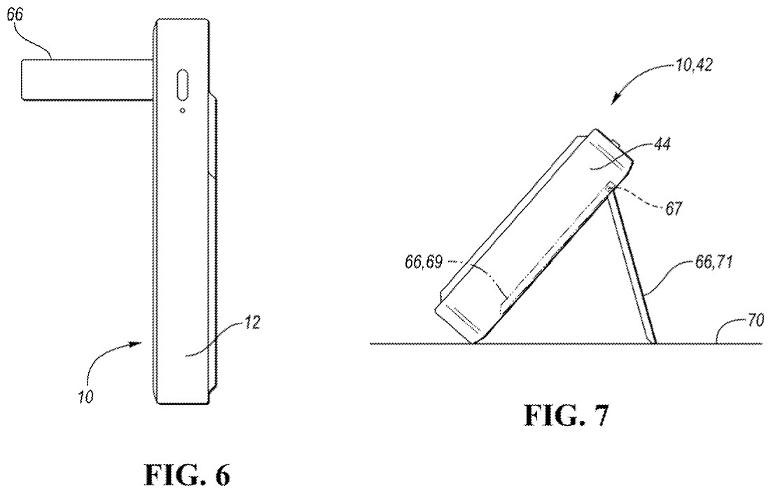

Referring to FIGS. 4 to 7, a front view, a rear view, a side view, and a bottom view of the power bank 10 with the adapter plug 42 attached to the power bank 10 are illustrated, respectively. In each of the views depicted in FIGS. 4 to 7, the magnetic fields from magnets 64 are engaging the housing 12 or other metallic components of the power bank 10 to secure the adapter plug 42 attached to the power bank 10. Also, in each of the views depicted in FIGS. 4 to 7, the pins 48 are engaging the electrical outlet (e.g., a port) defined by the power bank 10 to establish an electrical connection between the circuits of the adapter plug 42 and the power bank 10 as illustrated in FIG. 3

As shown in FIGS. 4 to 7, adapter plug 42 is attached to a bottom surface of housing 12 of power bank 10. In other embodiments, adapter plug 42 may be attached to other surfaces of housing 12. For instance, a side surface (e.g., front surface) or the end surface of adapter plug 42 may be attachable to a region of the front or rear surface of housing 12 or a region of the peripheral surface (e.g., top or side surfaces) of housing 12. The attachment may be facilitated by embedding one or more magnets in the region of housing 12 configured to receive adapter plug 42. FIGS. 8 and 9 depict an alternative configuration for attaching adapter plug 42 to the power bank 10. As shown in FIGS. 8 and 9, the front surface of adapter plug 42 is attached to a lower portion of the front surface of the power bank 10.

In one or more embodiments, a single adapter plug may include circuitry configured to charge power banks with different charging rates (e.g., 5 KmAh, 10 KmAh, and 15 KmAh, etc.). Therefore, the single adapter plug may have versatility to be used with any size power bank. The adapter may have a USB port (e.g., a USB-C port) so that another device can charge off the adapter plug via a USB cable.

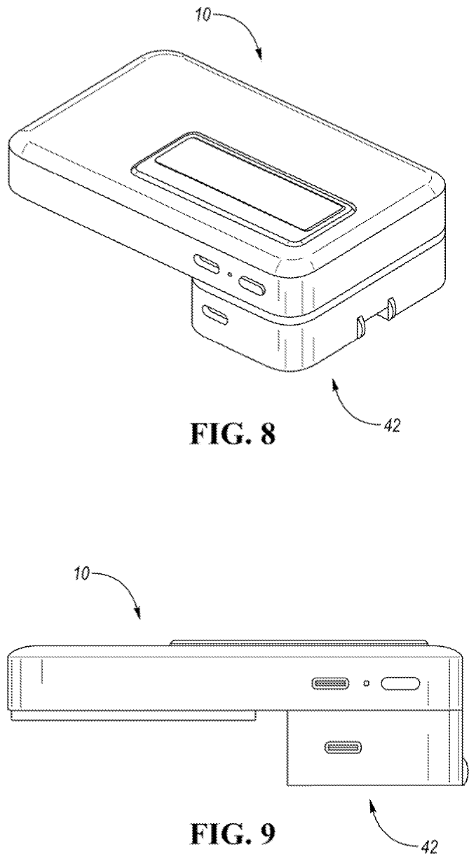

The power bank 10 may further include a kickstand 66 that is rotatably secured to the housing 12 of the power bank 10. The kickstand 66 may be rotatably secured to the housing 12 of the power bank 10 via pin 67. The kickstand 66 may be configured to transition between a stowed or retracted position 69 where the kickstand 66 is received within a slot 68 defined by one of the external panels 14 of the housing 12 and an operational or advanced position 71 where the kickstand 66 extends from the housing 12 and is configured to prop-up the power bank 10 when the power bank 10 is resting upon a flat surface 70 (e.g., see FIG. 7). In the retracted position 69, an exterior surface of the kickstand 66 may be flush with the exterior surface of the external panel 14 defining the slot 68. In the advanced position 71, the kickstand 66 may be orientated at an angle relative to the housing 12. Angular movement of the kickstand 66 may be limited to positions between the retracted position 69 and the advanced position 71. For example, a stop or stopping surface on the kickstand 66 or housing 12 may prevent movement of the kickstand 66 beyond the advanced position 71. The power bank 10 may also include snaps or clips that may facilitate retention of the kickstand 66 when the kickstand 66 is in the retracted position 69. A torsion spring may be disposed about the pin 67 that rotatably secures the kickstand 66 to the housing 12. Such a torsion spring may bias the kickstand 66 toward the retracted position 69.

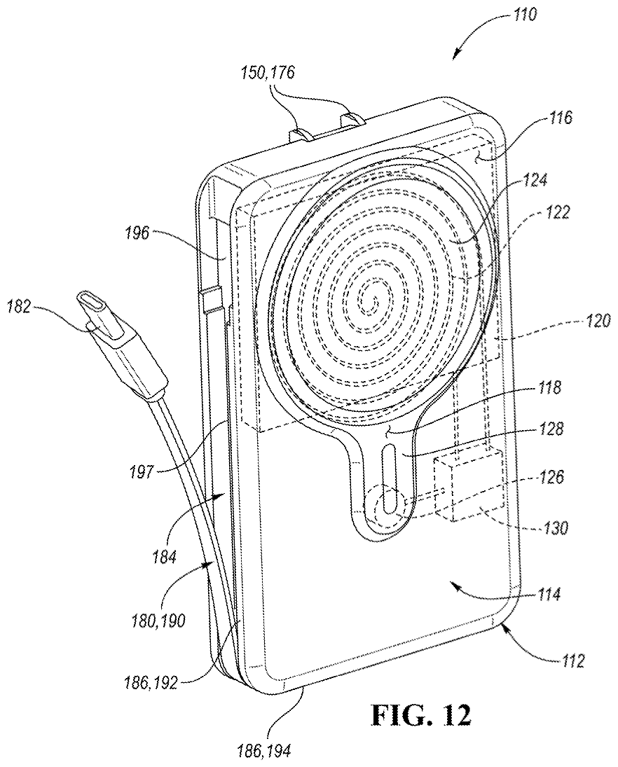

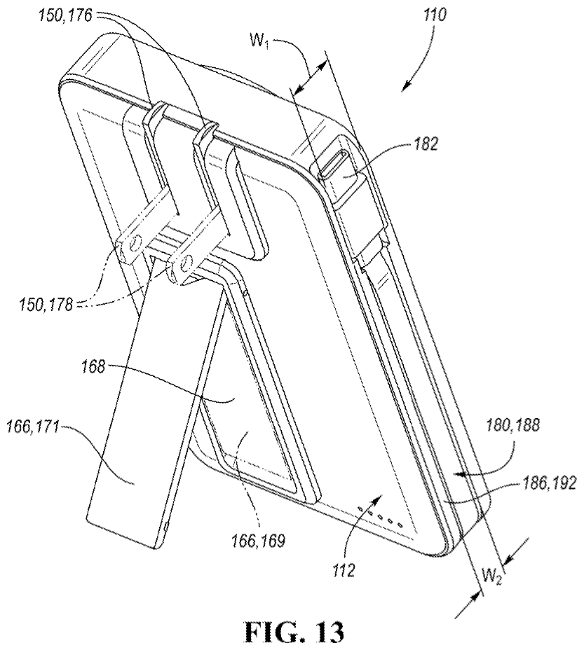

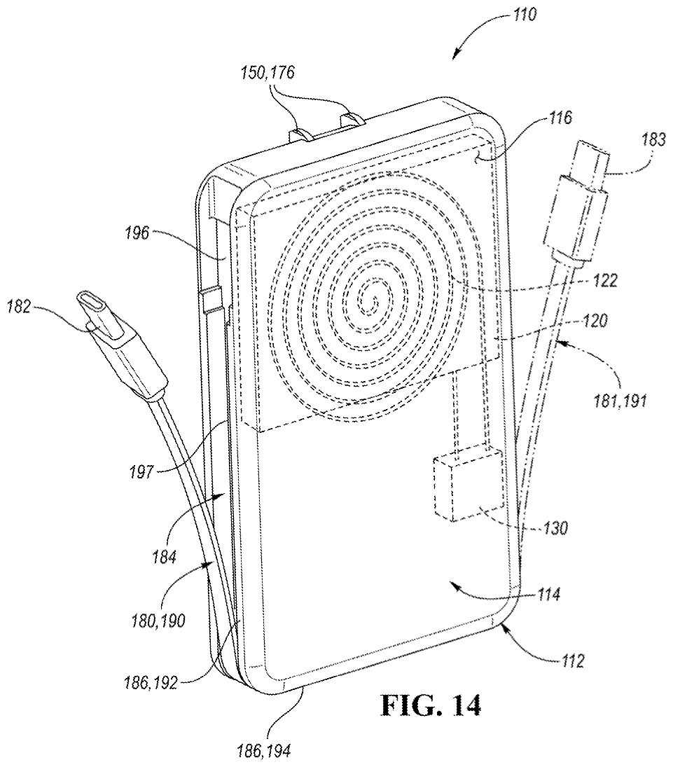

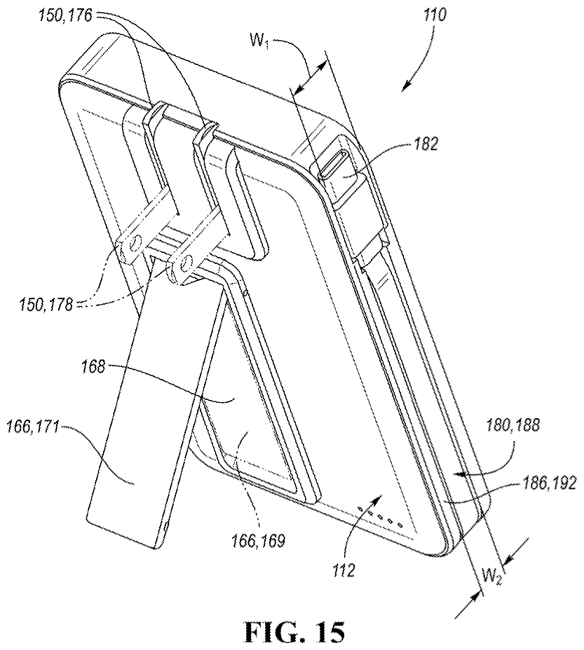

The adapter plug 42 may further define slots 72. The prongs 50 may be rotatably secured to the housing 44 of the adapter plug 42. Each prong 50 may be rotatably secured to the housing 44 of the adapter plug 42 within one of the slots 72 via a pin 74. Alternatively, each prong 50 may be disposed within a common slot. The prongs 50 are configured to rotate into and out of the slots 72 between a stowed or retracted position 176 where a major portion or all of each prong 50 is tucked away within the slots 72 (e.g., see FIGS. 12 and 14) and an operational or advanced position 178 where the major portions of each prong 50 extend out of the slots 72 (e.g., see FIGS. 13 and 15). The prongs 50 are configured to engage the electrical wall outlet 52 when in the advanced position 78 but not when in the retracted position 76.

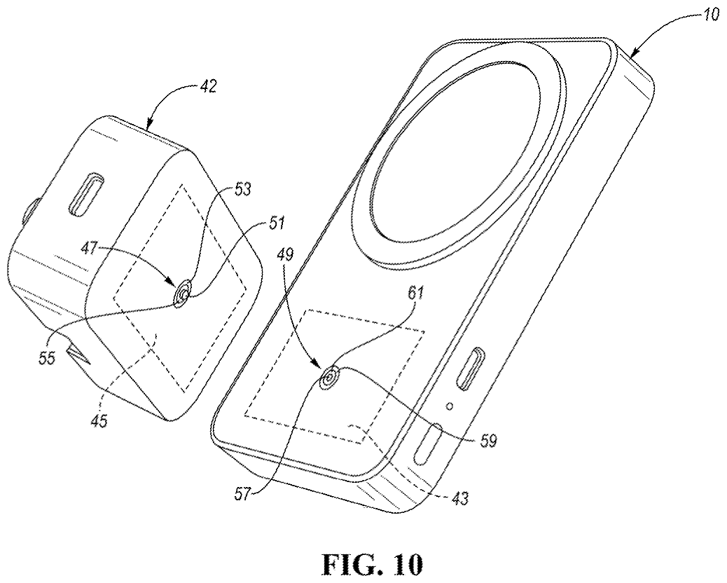

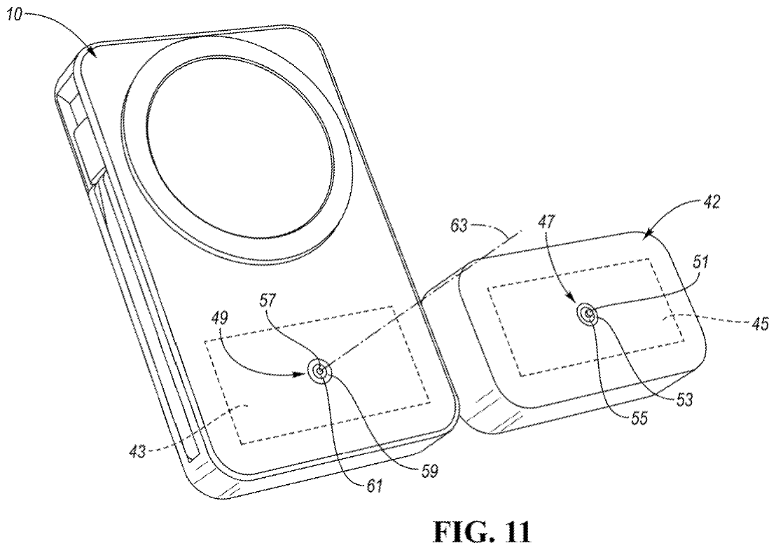

Referring to FIGS. 10 and 11, an alternative embodiment of the power bank 10 and adapter plug 42 is illustrated. The power bank 10 and adapter plug 42 illustrated in FIGS. 10 and 11 may include the elements of power bank 10 unless otherwise stated herein. Furthermore, the power bank 10 illustrated in FIGS. 10 and 11 may include any of the additional components of the power bank 110 illustrated in FIGS. 12-18. The adapter plug 42 is configured to attach to a lower portion of the front surface of the power bank 10 (e.g., see FIGS. 8 and 9). One or more magnets 43 may be disposed below the lower portion of the front surface of the power bank 10, and the one or more magnets 43 may interact with one or more attachment elements 45 on the adapter plug 42 that are capable of being magnetized (e.g., a ferrous plate or an additional magnet that is disposed below an outer surface of the adapter plug 42) to attach the adapter plug 42 to the lower portion of the front surface of the power bank 10. Alternatively, the magnets 43 may be disposed on the adapter plug 42 while the one or more elements 45 are disposed on the power bank 10. In one or more embodiments, the one or more magnets are carried by the adapter plug and the one or more attachment elements are carried by the power bank.

The electrical connection between the adapter plug 42 and the battery (e.g., battery 20) of the power bank 10 is established via a connector 47 disposed on the adapter plug 42 that engages an outlet or connector 49 on the power bank 10. As shown in FIGS. 10 and 11, the connector 47 includes a pin 51 and a secondary electrical contact 53. The secondary electrical contact 53 is disposed around the pin 51 in a concentric configuration. The pin 51 and secondary electrical contact 53 may be separated by a material 55 that electrically insulates the pin 51 from the secondary contact 53. The connector 49 includes a socket or primary electrical contact 57 and a secondary electrical contact 59. The secondary electrical contact 59 is disposed around the primary electrical contact 57 in a concentric configuration. The primary electrical contact 57 and secondary electrical contact 59 may be separated by a material 61 that electrically insulates the primary electrical contact 57 from the secondary contact 59. In one or more embodiments, the connector 47 may be carried on the power bank 10 and the connector 49 may be carried on the adapter plug 42.

The pin 51 is configured to engage the primary electrical contact 57 and the secondary electrical contact 53 is configured to engage the secondary electrical contact 59 to establish the electrical connection between the adapter plug 42 and the battery (e.g., battery 20) of the power bank 10 (e.g., in a similar manner as the connection between the electrical outlet 31 and prong 48 as illustrated in FIG. 3). The concentric configuration of both connectors 47, 49 allows for the adapter plug 42 to be attached to the power bank 10 at any orientation as long as the pin 51 remains connected to the primary electrical contact 57 and as long as the secondary electrical contact 53 remains connected to the secondary electrical contact 59. The adapter plug 42 may be rotated along axis 63 to any desired orientation as long as the pin 51 remains connected to the primary electrical contact 57 and as long as the secondary electrical contact 53 remains connected to the secondary electrical contact 59.

Referring to FIGS. 12 to 18, the power bank 110 is illustrated. Referring to these Figures, a power bank 110 configured to charge portable devices (e.g., mobile phones) external to the power bank 110 is illustrated. The power bank 110 includes a housing 112 that is comprised of a plurality of external panels. A first of the external panels 14 has a lower surface 116 and an elevated surface 118 (although the embodiment shown in FIGS. 14 and 15 does not include an elevated surface or a sensor). A battery 120 (or a bank of batteries or battery cells) is disposed within the housing 112 (e.g., within an internal cavity defined by the housing 112). The battery 120 is configured to store electrical power. A primary coil 122 is disposed within the housing 112 and below a first portion 124 of the elevated surface 118 (as shown in FIGS. 12 and 13). A sensor 126 is disposed within the housing 112 and below a second portion 128 of the elevated surface 118 (as shown in FIGS. 12 and 13). The sensor 126 may be any type of sensor that is configured to detect magnetic fields, such as a hall-effect sensor. The first portion 124 of the elevated surface 118 may be a circular-shaped area and the second portion 128 of the elevated surface may be a linear-shaped area that protrudes from the circular-shaped area.

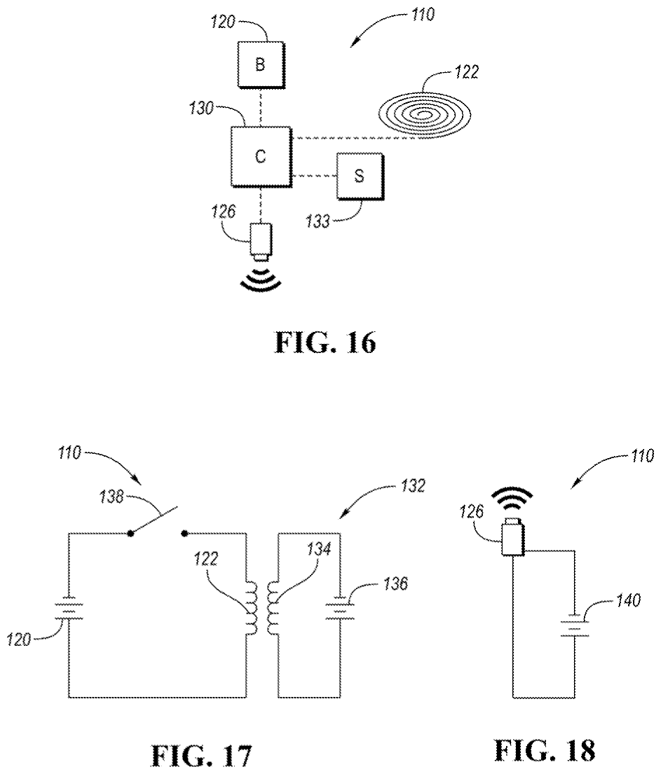

The power bank 110 also includes a controller 130. The controller 130 may also be disposed within the housing 112. The controller 130 is in communication with the battery 120, the primary coil 122, and the sensor 126 via input and output channels illustrated as dotted lines in FIG. 16. Each dotted line may represent input and output channels to and from each component of the power bank 110. The input and output channels may be comprised of electrical wires that transmit electrical signals between the various components of the power bank 110.

The controller 130 includes algorithms configured to control the various components of the power bank 10. For example, the controller 130 may be programmed to, in response to the sensor 126 detecting magnetic fields external to the power bank 110, deliver electrical power from the battery 120 to the primary coil 122. The magnetic fields external to the power bank 110 may be magnetic fields generated by portable devices, such as mobile phones, and may be detected in response to the portable devices being disposed on or proximate to the elevated surface 118. In one or more embodiments, “on” may refer to the portable device contacting the receiving external surface of the power bank packaging. In one or more embodiments, “proximate to” may refer to the portable device being close (e.g., 5 mm, 4 mm, 3 mm, 2 mm, 1 mm, 0.5 mm or less) but not contacting the receiving external surface. The magnetic fields may be magnetic fields generated by secondary coils or magnets that are subcomponents of the portable devices. The sensor 126 detecting a magnetic field may indicate that a portable device has been disposed on or proximate to the elevated surface 118 so that the power bank 110 may charge a battery of the portable device. The sensor 126 detecting the magnetic field may indicate that a distance between the primary coil 122 of the power bank 110 and a secondary coil within the portable device is small enough (e.g., 5 mm, 4 mm, 3 mm, 2 mm, 1 mm, 0.5 mm or less) so that the primary coil 122 may deliver electrical power from the battery 120 to the secondary coil via induction in order to charge a battery of the portable device.

The controller 130 may also be programmed to, in response to an absence of the sensor 126 detecting magnetic fields, forgo delivering electrical power from the battery 120 to the primary coil 122. The absence of detecting magnetic fields may indicate that no portable device is present for charging (e.g., that no portable device has been disposed on or proximate to the elevated surface 118 so that the power bank 110 may charge the battery of the portable device via induction).

While illustrated as one controller, the controller 130 may be part of a larger control system and may be controlled by various other controllers throughout the power bank 110. The controller 130 and one or more other controllers can collectively be referred to as a “controller” that controls various subcomponents of the power bank 110 in response to signals from various sensors to control functions the power bank 110 or power bank subsystems. The controller 30 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory configured to store various operating variables while the CPU is powered down. Computer-readable storage devices or media may be implemented using PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 130 in controlling the power bank 110 or power bank subsystems.

Control logic or functions performed by the controller 130 may be represented by flow charts or similar diagrams in one or more figures. These figures provide representative control strategies and/or logic that may be implemented using one or more processing strategies such as event-driven, interrupt-driven, multi-tasking, and multi-threading. As such, various steps or functions illustrated may be performed in the sequence illustrated, in parallel, or in some cases omitted. One or more of the illustrated steps or functions may be repeatedly performed depending upon the particular processing strategy being used. Similarly, the order of processing is not necessarily required to achieve the features and advantages described herein but is provided for case of illustration and description.

The control logic may be implemented primarily in software executed by a microprocessor-based controller, such as controller 130. The control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the power bank 110 or its subsystems. The computer-readable storage devices or media may include one or more of a number of known physical devices which utilize electric, magnetic, and/or optical storage to keep executable instructions and associated calibration information and operating variables.

The power bank 110 may also include an electrical outlet or port configured to receive an adapter or power cord. The adapter or power cord may in turn be configured to plug into an electrical power outlet to deliver power to the battery 120 via the port to charge the battery 120. The port may be configured to receive pogo or spring-loaded pins that are attached to the adapter or power cord. The port may be defined along the exterior of the housing 112. The power bank 110 may also include an ON/OFF switch configured to turn the power bank 110 on and off if charging a portable device is desired or is not desired, respectively.

Referring to FIG. 3, an electrical diagram including an electrical circuit of the power bank 110 and an electrical circuit of a portable device 132, such as a mobile phone, chargeable by the power bank 110 are illustrated. The electrical circuit of the power bank 110 is disposed within the housing 112. The portable device 132 is external to the power bank 110. The primary coil 122 of the power bank 110 is configured to interact with a secondary coil 134 of the portable device 132 to deliver power from the battery 120 of the power bank 110 to a battery 136 of the portable device 132 to charge the battery 136 of the portable device 132 in response to the portable device 132 being disposed proximate to the elevated surface 118 (e.g., the portable device 132 being disposed on or proximate to the elevated surface 118 so that the power bank 110 may charge the battery 136 of the portable device 132 via induction through the interaction between the primary coil 122 and the secondary coil 134).

The power bank 110 may include a switch 138. The switch 138 may be configured to close to deliver power to the primary coil 122 in response to the sensor 126 detecting a magnetic field generated by the portable device 132. The switch may also be configured to open to stop delivery of power to the primary coil 122 in the absence of detecting a magnetic field generated by the portable device 132. The switch 138 may be controlled by the controller 130, may be internal to the controller 130 (e.g., the switch 138 may comprise a transistor that switches on or off based on the state of the sensor 126), or the switch 138 may be integral to the sensor 126 (e.g., the sensor 126 includes the switch 138 and closes or opens the switch 38 in response to detecting or not detecting an external magnetic field, respectively). The outlet may also be connected to the battery 120 so that an adapter or power cord may deliver power to the battery 120 to recharge the battery 120.

Referring to FIG. 16, an electrical diagram of a circuit including the sensor 126 and a power source 140 for the sensor 126 is illustrated. The power source 140 for the sensor 126 may be battery 120. However, to prevent the sensor 126 from draining the battery 120 of the power bank 110, the power source 140 for the sensor 126 may be external to battery 120. For example, the power source 140 may be a secondary battery that is integral to the power bank 110 (e.g., a secondary battery disposed within the housing 112 of the power bank 110) or may be a secondary battery disposed external to the power bank 110 but within a common packaging or container. The power source 140 being a battery separate from battery 120 may be advantageous when the power bank 110 is disposed within a packaging container, is on display for sale, and is configured to allow a consumer to test the operability of the power bank 110 while it is still within the packaging container. This may minimize the amount of power from the battery 120 that is consumed via the sensor 126. If the battery 120 runs out of power under such a scenario, the consumer is not be able to test the operability of the power bank 110 without removing the power bank 110 from the packaging or container and plugging the power bank 110 into an electrical outlet via a power cord or adapter that engages port, which could likely lead to the purchasing the power bank 110 without having the opportunity to test the functionality of the power bank 110.

The electrical diagrams in FIGS. 17 and 18 are for illustrative purposes. The power bank 10 may include additional electrical elements that are not illustrated, and some of the elements may be rearranged (e.g., elements that are shown to be in parallel may be rearranged to be in series or elements that are shown to be in series may be rearranged to be in parallel).

The power bank 110 may further include a kickstand 166 that is rotatably secured to the housing 112 of the power bank 110. More specifically, the kickstand 166 may be rotatably secured to the housing 112 of the power bank 110 via a pin (e.g., see pin 67 in FIG. 5). The kickstand 166 may be configured to transition between a stowed or retracted position 169 where the kickstand 166 is received within a slot 168 defined by one of the external panels 114 of the housing 112 and an operational or advanced position 171 where the kickstand 166 extends from the housing 112 and is configured to prop-up the power bank 110 when the power bank 110 is resting upon a flat surface. In the retracted position 169, an exterior surface of the kickstand 166 may be flush with the exterior surface of the external panel defining the slot 168. In the advanced position 171, the kickstand 166 may be orientated at an angle relative to the housing 112. Angular movement of the kickstand 166 may be limited to positions between the retracted position 169 and the advanced position 171. For example, a stop or stopping surface on the kickstand 166 or housing 112 may prevent movement of the kickstand 166 beyond the advanced position 171. The power bank 110 may also include snaps or clips that may facilitate retention of the kickstand 166 when the kickstand 166 is in the retracted position 169. A torsion spring may be disposed about the pin that rotatably secures the kickstand 166 to the housing 112. Such a torsion spring may bias the kickstand 166 toward the retracted position 169.

The power bank 110 also includes prongs 150 that protrude from the housing 112. The prongs 150 are configured to engage the electrical wall outlet 52. The electrical wall outlet 52 is connected to and configured to receive power from a power source, such as a power grid 54. The prongs 150 may also be disengaged from the electrical wall outlet 52. The prongs 150 engage the electrical wall outlet 52 to deliver electrical power from the electrical wall outlet 52 to the battery 120 to charge the battery 120. The prongs 150 are connected to or form a portion of the circuit that includes the battery 120.

The housing 112 may further define slots (e.g., see slots 72 in FIG. 4). The prongs 150 may be rotatably secured to the housing 112. Each prong 150 may be rotatably secured to the housing 112 within one of the slots via a pin (e.g., see pin 74 in FIG. 4). Alternatively, each prong 150 may be disposed within a common slot. The prongs 150 are configured to rotate into and out of the slots between a stowed or retracted position 176 where a major portion or all of each prong 150 is tucked away within the slots and an operational or advanced position 178 where the major portions of each prong 150 extend out of the slots. The prongs 150 are configured to engage the electrical wall outlet 52 when in the advanced position 178 but not when in the retracted position 176.

The power bank 110 may also include a cable 180 that is secured to the housing 112. The cable 180 may be integrated into the circuit of the power bank 110 that includes the battery 120. The cable 180 includes a connector 182. The connector 182 may be configured to engage an electrical port that is connected to an external power source such that electrical power is delivered from the external power source to the battery 120 via cable 180 to charge the battery 120. The connector 182 may also be configured to engage an electrical port that is on a portable device (e.g., portable device 32) such that electrical power is delivered from the battery 120 to the battery of the portable device (e.g., battery 36) via cable 180 to charge the battery of the portable device. The power bank 110 may also include second cable 181, which includes second connector 183.

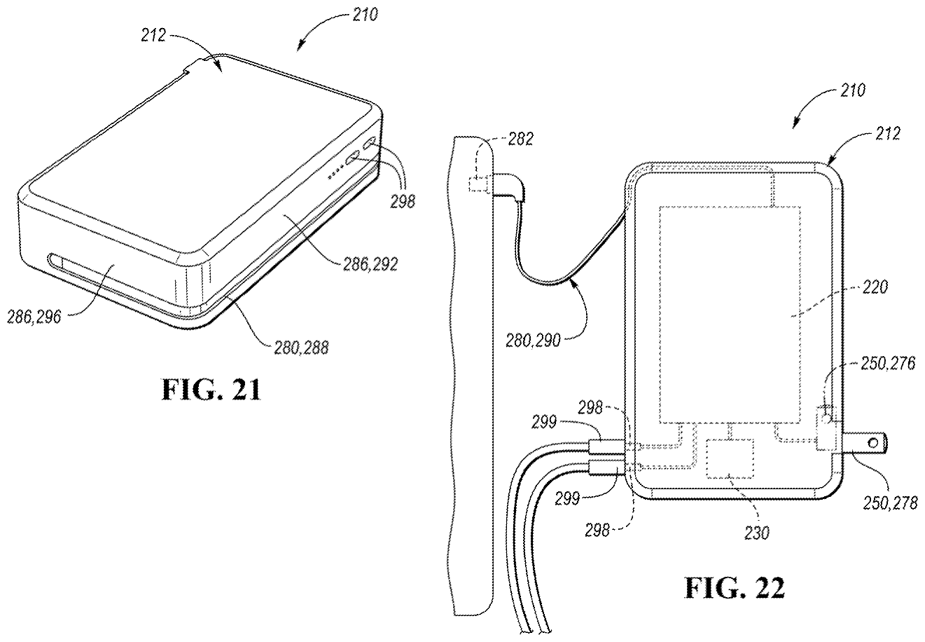

The housing 112 may define a slot 184 along periphery or an external edge 186 of the housing 112. The cable 180 may be configured to be disposed within the slot 184 when in a stowed or retracted position 188. The cable may be configured to be at least partially external to the slot 184 when in an operation or advanced position 190. Second cable 181 is shown in advanced position 191 in FIG. 14. The slot 184 may be defined along a side edge 192 and a lower edge 194 of the housing 112, similar to what is shown in FIG. 21. A portion 196 of the slot 184 that is configured to receive the connector 182 of the power cable 180 may have a width W1 that is larger than a width W2 of the remainder 197 of the slot 184. The cable 180 may be a USB cable while the connector 182 may be a USB connector. The cable 180 may be a USB-C cable while the connector 182 may be a USB-C connector. The housing 112 may have a second slot on an opposing side edge including a second slot configured as a mirror image of cable 180.

The power bank 110 may also include an ON/OFF switch configured to turn the power bank 110 on and off if charging a portable device is desired or is not desired, respectively. The circuits illustrated in FIGS. 16 to 18 may be representative of the circuit of the power bank 110. However, the electrical circuit of the power bank 110 may include a circuit that is a combination or integration of the electrical circuit 56 of the adapter plug 42 and the circuit of the power bank 10 (e.g., the connection between the electrical outlet 31 and prong 48 is eliminated and replaced by a hardwired non-detachable connection that integrates the circuit 56 of the adapter plug 42 and the circuit of the power bank 10 into a single circuit that is incorporated into the power bank 110). The electrical circuit of the power bank 110 may also include an electrical connection between the cable 180 and the battery 120. The power bank 110 may be sized for any desirable charging operation. For example, the power bank 110 include any desirable charging rate, including but not limited to charging rates of 5 KmAh, 10 KmAh, and 15 KmAh.

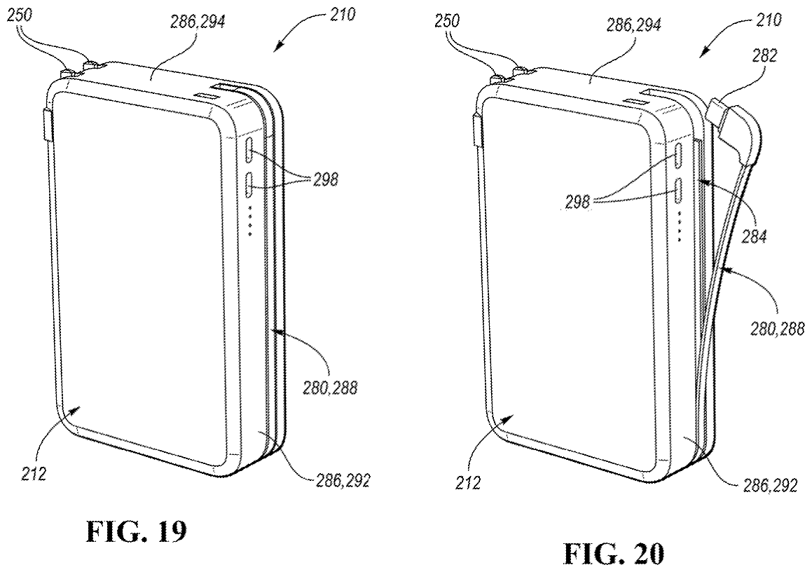

Referring to FIGS. 19 to 22, power bank 210 is illustrated. The power bank 210 is configured to charge portable devices external to the power bank 210, such as a mobile phone. The power bank 210 includes a housing 212 that is comprised of a plurality of external panels. A battery 220 (or a bank of batteries or battery cells) is disposed within the housing 212 (e.g., within an internal cavity defined by the housing 212). The battery 220 is configured to store electrical power.

The power bank 210 also includes a controller 230. The controller 230 may also be disposed within the housing 212. The controller 230 is in communication with the battery 220 and various electrical connections (described below) via input and output channels illustrated as dotted lines in FIG. 22. Each dotted line may represent input and output channels to and from each component of the power bank 210. The input and output channels may be comprised of electrical wires that transmit electrical signals between the various components of the power bank 210.

The controller 230 includes algorithms configured to control the various components of the power bank 210. For example, the controller 230 may be programmed to, in response to an electrical connection to the battery 220, deliver or receive power from to or from an external source (e.g., a power grid or a battery of a connected portable device) via the electrical connection. In another example, the controller 230 may be programmed to, in response to an electrical disconnection from the battery 220, cease delivering or receiving power from to or from the external source.

While illustrated as one controller, the controller 230 may be part of a larger control system and may be controlled by various other controllers throughout the power bank 210. The controller 230 and one or more other controllers can collectively be referred to as a “controller” that controls various subcomponents of the power bank 210 in response to signals from various sensors to control functions the power bank 210 or power bank subsystems. The controller 230 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory configured to store various operating variables while the CPU is powered down. Computer-readable storage devices or media may be implemented using PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller 230 in controlling the power bank 210 or power bank subsystems.

Control logic or functions performed by the controller 230 may be represented by flow charts or similar diagrams in one or more figures. These figures provide representative control strategies and/or logic that may be implemented using one or more processing strategies such as event-driven, interrupt-driven, multi-tasking, and multi-threading. As such, various steps or functions illustrated may be performed in the sequence illustrated, in parallel, or in some cases omitted. One or more of the illustrated steps or functions may be repeatedly performed depending upon the particular processing strategy being used. Similarly, the order of processing is not necessarily required to achieve the features and advantages described herein but is provided for ease of illustration and description.

The control logic may be implemented primarily in software executed by a microprocessor-based controller, such as controller 230. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the power bank 210 or its subsystems. The computer-readable storage devices or media may include one or more of a number of known physical devices which utilize electric, magnetic, and/or optical storage to keep executable instructions and associated calibration information and operating variables.

The power bank 210 also includes prongs 250 that protrude from the housing 212. The prongs 250 are configured to engage the electrical wall outlet 52. The electrical wall outlet 52 is connected to and configured to receive power from a power source, such as a power grid 54. The prongs 250 may also be disengaged from the electrical wall outlet 52. The prongs 250 engage the electrical wall outlet 52 to deliver electrical power from the electrical wall outlet 52 to the battery 220 to charge the battery 220. The prongs 250 are connected to or form a portion of the circuit that includes the battery 220.

The housing 212 may further define slots (e.g., see slots 72 in FIG. 4). The prongs 250 may be rotatably secured to the housing 212. More specifically, each prong 250 may be rotatably secured to the housing 212 within one of the slots via a pin (e.g., see pin 74 in FIG. 4). Alternatively, each prong 250 may be disposed within a common slot. The prongs 250 are configured to rotate into and out of the slots between a stowed or retracted position 276 where a major portion or all of each prong 250 is tucked away within the slots and an operational or advanced position 278 where the major portions of each prong 250 extend out of the slots. The prongs 250 are configured to engage the electrical wall outlet 52 when in the advanced position 278 but not when in the retracted position 276.

The power bank 210 may also include a cable 280 that is secured to the housing 212. The cable 280 may be integrated into the circuit of the power bank 210 that includes the battery 220. The cable 280 includes a connector 282. The connector 282 may be configured to engage an electrical port that is connected to an external power source such that electrical power is delivered from the external power source to the battery 220 via cable 280 to charge the battery 220. The connector 282 may also be configured to engage an electrical port that is on a portable device (e.g., portable device 132) such that electrical power is delivered from the battery 220 to the battery of the portable device (e.g., battery 136) via cable 280 to charge the battery of the portable device.

The housing 212 may define a slot 284 along periphery or an external edge 286 of the housing 212. The cable 280 may be configured to be disposed within the slot 284 when in a stowed or retracted position 288. The cable may be configured to be at least partially external to the slot 284 when in an operation or advanced position 290. The slot 284 may be defined along a side edge 292, an upper edge 294, and a lower edge 296 of the housing 212. The cable 280 may be a USB cable while the connector 282 may be a USB connector. The cable 280 may be a USB-C cable while the connector 282 may be a USB-C connector.

The housing 212 may define at least one electrical port 298 that is configured to receive an electrical connector 299 connected to an external power source such that electrical power is delivered from the external power source to the battery 220 via the connection between the at least one electrical port 298 and the electrical connector 299 connected to the external power source. The at least one electrical port 298 may also be configured to receive an electrical connector 299 that is connected to a portable device (e.g., portable device 32) such that electrical power is delivered from the battery 220 to the battery of the portable device (e.g., battery 136) via the connection between the at least one electrical port 298 and the electrical connector 299 connected to the portable device. The at least one electrical port 298 may be a USB port (e.g., a USB-C port).

The power bank 210 may also include an ON/OFF switch configured to turn the power bank 210 on and off if charging a portable device is desired or is not desired, respectively. The power bank 210 may be sized for any desirable charging operation. For example, the power bank 210 may include any desirable charging rate, including but not limited to charging rates of 67 W or 120 W.

In one embodiment, a power bank system configured to charge portable devices includes a housing, a first battery, an electrical circuit, a primary coil, and an adapter plug is disclosed. The housing has an external panel and defines an electrical housing outlet. The first battery is disposed within the housing and is configured to store electrical power. The electrical circuit disposed within the housing is configured to electrically connect the electrical housing outlet to the first battery. The primary coil is electrically connected to the first battery and is disposed within the housing below the external panel. The primary coil is configured to interact with a secondary coil of a portable device to deliver electrical power from the first battery to a second battery secured to the portable device to charge the second battery in response to the portable device being disposed on or proximate to the external panel. The adapter plug is disposed external to the housing, has electrical connectors configured contact the electrical housing outlet, and has prongs electrically connected to the electrical connectors. The prongs are configured to engage an electrical wall outlet. The prongs, electrical connectors, and electrical circuit are configured to deliver electrical power from the electrical wall outlet to the first battery to charge the first battery when the electrical connectors contact the electrical housing outlet and when the prongs engage the electrical wall outlet.

The power bank system may further include a second electrical circuit electrically connecting the prongs to the electrical connectors. The second electrical circuit may include a step-down converter configured to decrease a voltage from the electrical wall outlet delivered to the electrical connectors. The adapter plug may have a second housing that defines at least one slot, and the prongs are rotatably secured to the second housing, and the prongs are configured to rotate into and out of the at least one slot between stowed positions and operational positions, respectively. The power bank system may further include a kickstand rotatably secured to the housing. The adapter plug may include magnets that are disposed proximate to an external surface of the adapter plug. The magnets may be configured to engage the housing to secure the adapter plug to the housing. The magnets may be disposed on the first and second opposing sides of the electrical connectors. The agents and the electrical connectors may be disposed on an edge of the adapter plug.

A power bank configured to charge portable devices includes a housing, a first battery, prongs, and a cable. The first battery is disposed within the housing. The prongs are secured to the housing. The prongs are configured to engage an electrical wall outlet and deliver electrical power from the electrical wall outlet to the first battery to charge the first battery. The cable is secured to the housing and has a connector. The connector is configured to engage an electrical port such that electrical power is delivered from the electrical port to the first battery to charge the first battery or such that electrical power is delivered from the first battery to a second battery.

The housing may define at least one slot, and the prongs may be rotatably secured to the housing, and the prongs may be configured to rotate into and out of the at least one slot between stowed positions and operational positions, respectively. The prongs are configured to engage an electrical wall outlet when in the operational position but not when in the stowed position. The housing may define a slot along an external edge, and the cable may be configured to be disposed within the slot when in a stowed position, and the cable may be configured to be at least partially external to the slot when in an operational position. The slot may be defined along a side edge and an upper edge of the housing. The cable may be a USB cable. The housing may define at least one electrical port configured to receive an electrical connector. The power bank may further comprise a second cable secured to the housing. The second cable may have a second connector configured to engage a second electrical port such that electrical power is delivered from the second electrical port to the first battery to charge the first battery or electrical power is delivered from the first battery to a third battery.

The designations of first, second, third, fourth, etc. for any component, state, or condition described herein may be rearranged in the claims so that they are in chronological order with respect to the claims. Any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. An adapter plug for a power bank comprising:
a housing;
an electrical connector associated with the housing and configured to contact an electrical connector of a power bank defined by the power bank;
prongs configured to engage an electrical wall outlet; and
an electrical circuit (i) disposed within the housing and (ii) electrically connecting the prongs to the electrical connector associated with the housing, wherein the prongs, electrical circuit, and an electrical connector associated with the housing is configured to deliver electrical power from the electrical wall outlet to the power bank to recharge a battery of the power bank when (i) the electrical connector associated with the housing contacts the electrical connector of the power bank and (ii) the prongs engage the electrical wall outlet.

2. The adapter plug of claim 1, wherein the adapter plug is configured to charge a first electrical power bank with a first charging rate and a second electrical power bank with a second charging rate different than the first charging rate.

3. The adapter plug of claim 1, wherein (i) the housing defines at least one slot, (ii) the prongs are rotatably secured to the housing, and (iii) the prongs are configured to rotate into and out of the at least one slot between stowed positions and operational positions, respectively.

4. The adapter plug of claim 1 further comprising magnets configured to engage the power bank to secure the adapter plug to the power bank.

5. The adapter plug of claim 4, wherein the magnets are disposed on first and second opposing sides of the electrical connector of the housing.

6. The adapter plug of claim 5, wherein the magnets and the electrical connector of the housing are disposed on an edge of the adapter plug.

7. The adapter plug of claim 4, wherein the magnets are disposed proximate to an external surface of the adapter plug.

8. The adapter plug of claim 1 further comprising a port secured to the housing and configured to receive a cable configured to deliver electrical power from the electrical wall outlet to an electrical device connected to the cable.

9. The adapter plug of claim 8, wherein the cable is configured to deliver electrical power from the electrical wall outlet to the electrical device connected to the cable while the electrical wall outlet is delivering electrical power to the power bank through the prongs, electrical circuit, and the electrical connector of the housing.

10. A power bank configured to charge portable devices comprising:
a housing;
a first battery disposed within the housing;
a primary coil (i) electrically connected to the first battery and (ii) disposed within the housing and below an external panel, wherein the primary coil is configured to interact with a secondary coil of a portable device to deliver electrical power from the first battery to a second battery that is secured to the portable device to charge the second battery in response to the portable device being disposed on or proximate to the external panel; and
a cable (i) secured to the housing and (ii) having a connector, wherein the connector is configured to engage an electrical port such that (a) electrical power is delivered from the electrical port to the first battery to charge the first battery or (b) electrical power is delivered from the first battery to the second battery.

11. The power bank of claim 10, wherein (i) the housing defines a slot along an external edge, (ii) the cable is configured to be disposed within the slot when in a stowed position, and (iii) the cable is configured to be at least partially external to the slot when in an operation position.

12. The power bank of claim 11, wherein the slot is defined along a side edge and a lower edge of the housing.

13. The power bank of claim 11, wherein a portion of the slot that is configured to receive the connector of the power cable has a width that is larger than a width of the remainder of the slot.

14. The power bank of claim 10 further comprising a kickstand rotatably secured to the housing.

15. The power bank of claim 10 further comprising prongs secured to the housing and configured to (i) engage an electrical wall outlet and (ii) deliver electrical power from the electrical wall outlet to the first battery to charge the first battery.

16. The power bank of claim 15, wherein (i) the housing defines at least one slot, (ii) the prongs are rotatably secured to the housing, and (iii) the prongs are configured to rotate into and out of the at least one slot between stowed positions and operational positions, respectively.

17. The power bank of claim 16, wherein the prongs are configured to engage the electrical wall outlet when in the operational positions but not when in the stowed positions.

18. The power bank of claim 10, wherein the cable is a USB Cable.

19. The power bank of claim 10 further comprising a second cable (i) secured to the housing and (ii) having a second connector, wherein the second connector is configured to engage a second electrical port such that (a) electrical power is delivered from the second electrical port to the first battery to charge the first battery or (b) electrical power is delivered from the first battery to a third battery.

20. A power bank configured to charge portable devices comprising:
a housing;
a first battery disposed within the housing;
a primary coil (i) electrically connected to the first battery and (ii) disposed within the housing and below the external panel, wherein the primary coil is configured to interact with a secondary coil of a portable device to deliver electrical power from the first battery to a second battery secured to the portable device to charge the second battery in response to the portable device being disposed on or proximate to the external panel; and
a port secured to the housing and configured to receive a cable configured to deliver electrical power from an electrical wall outlet to the first battery to charge the first battery.
